(19) United States
(12) Patent Application Publication
(10) Pub. No.: US 2009/0114497 A1
(43) Pub. Date: May 7, 2009

(54) Inflatable Tube For Coupling Component And Method For Making An Inflatable Tube

(75) Inventors: James P. Barnhouse, Perrysburg, OH (US); John A. Kovacich, Waukesha, WI (US); Edward J. Hummelt, Greenfield, WI (US); Daniel W. Fellers, Brown Deer, WI (US); Theodore C. Kelly, North Olmsted, OH (US); Donald M. Danko, Brecksville, OH (US); Robert S. Tekesky, North Olmsted, OH (US); Paul J. Rollmann, Brown Deer, WI (US); John F. Neese, Jackson, TN (US); Kevin T. Perkins, Dyer, TN (US)

Correspondence Address: EATON CORPORATION;EATON CENTER, 1111 SUPERIOR AVENUE, CLEVELAND, OH, 44114, US

(73) Assignees: JAMES P. BARNHOUSE; JOHN A. KOVACICH; EDWARD J. HUMMELT; DANIEL W. FELLERS; THEODORE C. KELLY; DONALD M. DANKO; ROBERT S. TEKESKY; PAUL J. ROLLMANN; JOHN F. NEESE; KEVIN T. PERKINS

(21) Appl. No.: 11/933,876

(22) Filed: Nov. 1, 2007

(51) Int. Cl. F16D 25/00; B32B 37/02

(52) U.S. Cl. 192/57; 156/122

(57) ABSTRACT

An inflatable coupling component tube for a fluid-operated brake or clutch includes an elongated, generally tubular-shaped structure of predetermined length having two ends and a joint between the two ends that closes the tube to form a generally toroidal-shaped cavity. A coupling component for a fluid-operated brake or clutch that includes an inflatable tube, and a method of making an inflatable coupling component tube are also disclosed.

### BACKGROUND OF THE DISCLOSURE

The present invention relates to flexible inflatable tubes that are inflatable under pressure to operate or engage a coupling component used in a mechanism such as an industrial clutch or a brake.

Clutches and brakes used in industrial machinery and equipment may include a coupling component having an inflatable annular tube that is mounted on a rigid annular rim. Friction shoe assemblies are connected with the tube in an annular array. When pressurized, the tube is expanded to press the friction shoe assemblies against another coupling component to interconnect the two coupling components or retard relative motion therebetween.

Coupling components having this, construction have previously been made by a method that includes hand-building an inflatable annular tube, placing the inflatable annular tube in a mold, inflating the tube, and heating the mold to vulcanize the elastomeric material of the tube. This process is labor intensive and, accordingly, significantly increases the cost to manufacture the tube and the clutch or brake.

### BRIEF DESCRIPTION OF THE DRAWINGS

FIG. 1 is a perspective view, in partial cross-section, of an exemplary coupling component that includes and inflatable tube according to an embodiment of the present invention;

FIG. 2 is a perspective view of a tube shown in its finally manufactured condition prior to assembly into the coupling component of FIG. 1;

FIG. 3 is a perspective view of a generally tubular-shaped structure having several exposed layers supported on a mandrel, for use in the tube shown in FIG. 2;

FIG. 4 is a flow chart illustrating a method of making a tube according to an embodiment of the present invention;

FIG. 5 is a perspective view, in cross-section, of the generally tubular-shaped structure of FIG. 2 according to an embodiment of the invention, showing the fiber orientation in reinforced layers of the structure;

FIG. 6 is a detailed view of the structure shown in FIG. 4, further illustrating the fiber orientation in the reinforced layers of the structure; and

FIGS. 7 and 8 are exploded perspective views of a valve according to an embodiment of the present invention, for use in the tube shown in FIG. 2.

### DETAILED DESCRIPTION

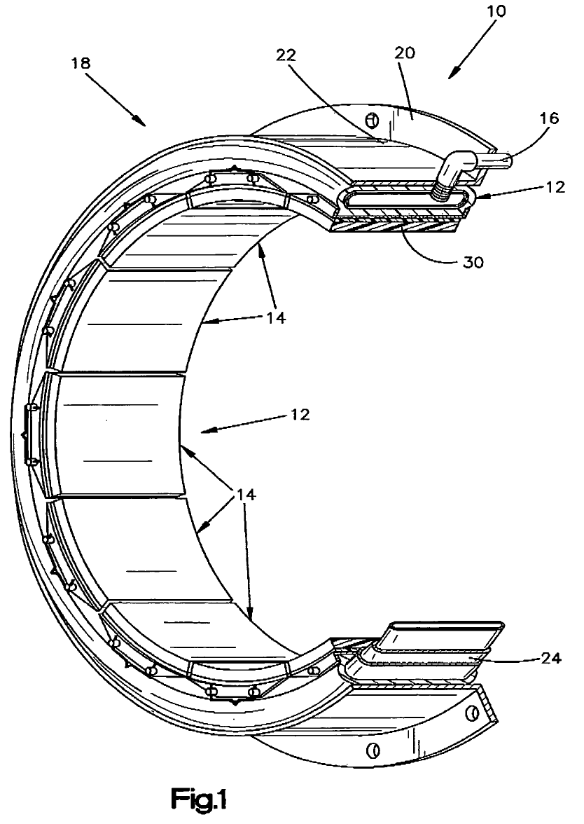

Referring now to the drawings, which are not intended to limit the invention, FIG. 1 illustrates an exemplary coupling component 10 that includes an inflatable tube 12 and an annular array of friction shoe assemblies 14. The friction shoe assemblies 14 are engageable with the outside of a drum or second coupling component (not shown) to interconnect the two coupling components. The exemplary coupling component 10 may function as part of either a brake or a clutch.

The friction shoe assemblies 14 are moved into engagement with the drum by radial expansion of the inflatable tube 12. Thus, when fluid pressure, such as air pressure, is conducted through a conduit 16 into the annular tube 12, the tube expands radially inwardly. This causes the tube 12 to press the friction shoe assemblies 14 against the drum. The friction between the shoe assemblies 14 and drum interconnect the drum and the coupling component 10.

In the illustrated coupling component 10, a rigid annular metal rim 18 is connected with the inflatable tube 12. The rim 18 has an annular mounting flange 20 which is used to connect the coupling component 10 with an associated apparatus or support structure (not shown). The rim 18 has a cylindrical web 22 with a radially inner side surface which is bonded to a radially outer side wall portion of the tube 12. Upon inflation of the tube 12 to press the friction shoes 14 against a drum or other coupling component, torque is transmitted between the friction shoe assemblies and the rim 18. To enable the tube 12 to withstand relatively large torque forces, one or more reinforced and non-reinforced layers 24 are provided in the tube 12 as will be described in further detail below.

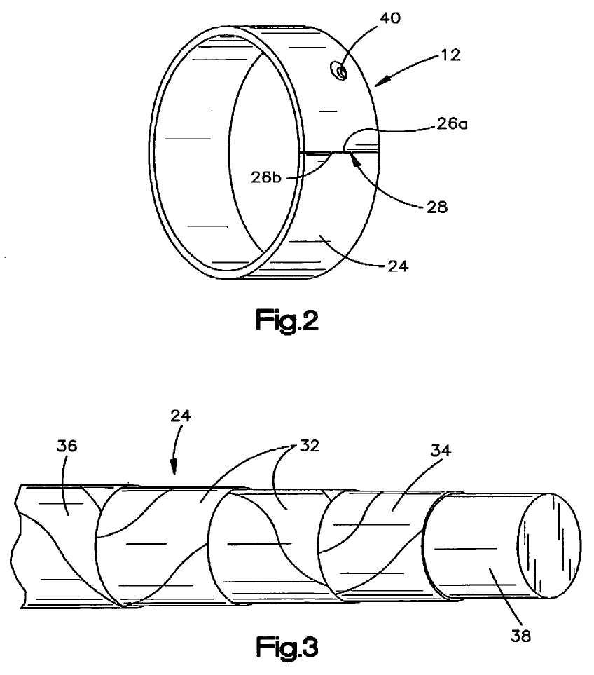

Referring to FIGS. 2 and 3, a tube 12 according to an embodiment of the present invention is shown, In FIG. 2, tube 12 is shown in its finally manufactured condition prior to assembly into coupling component 10. The tube 12 includes an elongated, generally tubular-shaped structure 24 of predetermined length having two ends 28a, 28b and a joint 28 between the two ends that closes the tube 12 to form a continuous toroidal-shaped cavity 30 (see, e.g., FIG. 1).

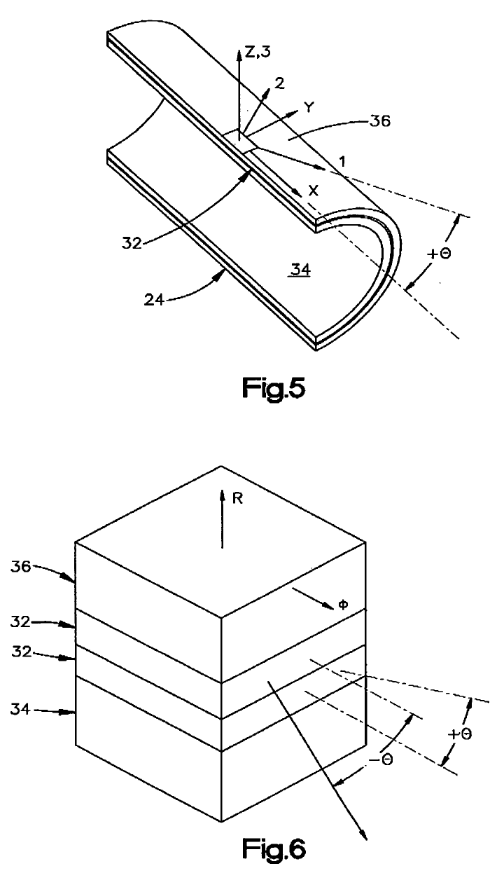

In an embodiment, tube 12 includes at least one reinforced layer 32 sandwiched between an inner, unreinforced layer 34 and an outer, unreinforced layer 36. However, it will be appreciated that tube 12 may have any number of layers, including for example, multiple reinforced layers 32 as shown in FIGS. 3 and 6, or only a single unreinforced layer 34, 36 positioned inwardly or outwardly of the reinforced layer 32.

The tube 12 is constructed by building the elongated, generally tubular-shaped structure 24, cutting the tubular-shaped structure 24 into predetermined lengths and joining the ends 26a, 26b of each length at the joint 28 to form the toroidal-shaped tube 12. While a range of elastomers may be used in the unreinforced layers 32 to facilitate this construction, including uncured thermoset and thermoplastic elastomers, thermoplastic elastomers provide the best blend of efficiency and integrity when joining the two ends. Thermoplastic polyurethane is particularly suited for tubes used in clutches given its good overall balance of mechanical, thermal, chemical and aging performance. Similarly, while a variety of organic and inorganic fibers may be used in the reinforced layers, organic fibers such as polyester, nylon, and rayon are particularly suited for use in tube 12 given their relatively low cost, low stiffness and generally acceptable thermal performance. Polyester fiber including multiple twisted fiber bundles similar to bundles used in the vehicle tire and industrial hose, industries—commonly referred to as “tire cord”—is particularly, but not exclusively suited for use in tube 12; however, if is recommended that traditional resorcinol formaldehyde latex fiber sizing used with thermoset elastomers be replaced with isocyanate, blocked isocyanate, or epoxy sizing to provide more robust adhesion to the thermoset elastomer.

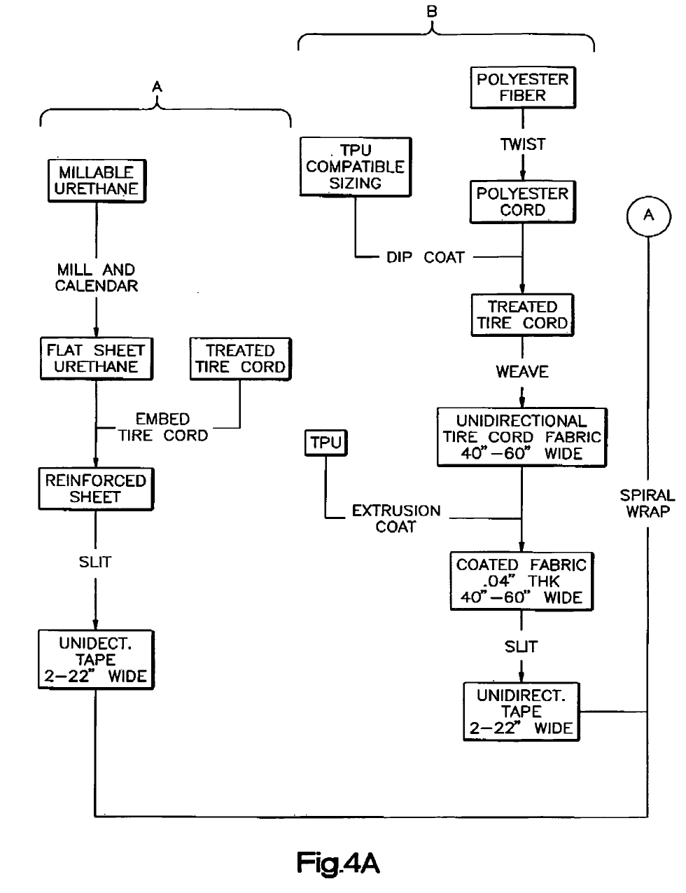

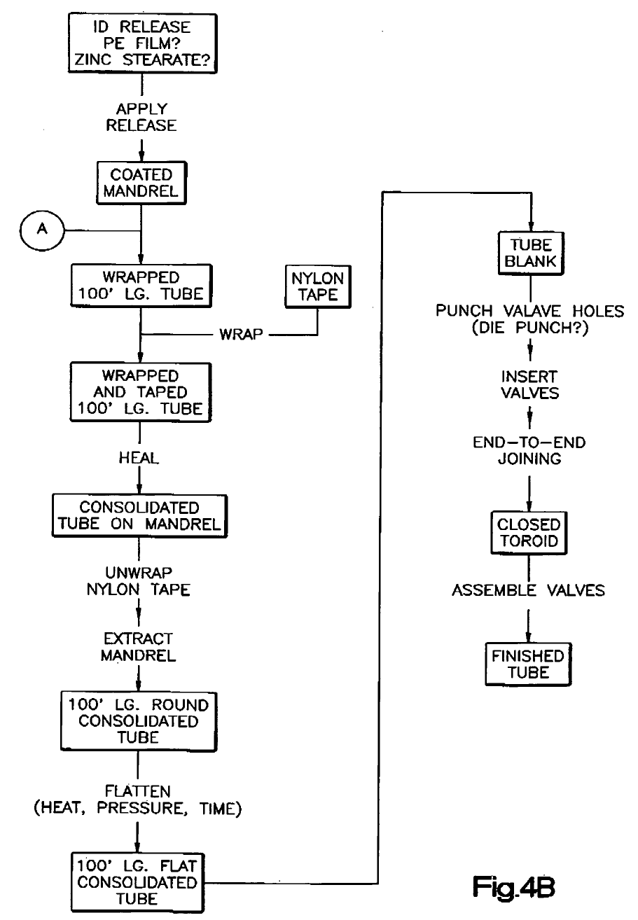

With reference to FIG. 4, a method for making tube 12 according to an embodiment of the present invention will now be described. In the illustrated embodiment, each reinforced layer 32 may be constructed by producing a semi-continuous sheet of elastomer coated, unidirectional fiber or fabric. As shown in option A, a thermoset elastomer, such as urethane, may be milled and calendared into a generally fiat sheet of predetermined width within which a treated fiber or fabric, such as tire cord, may be imbedded in accordance with methods well know in the art. Alternatively, as shown in option B, a reinforced fiber, including without limitation polyester, may also be twisted into cord and coated with a compatible sizing (i.e., adhesion promoter), then woven into a unidirectional fabric of predetermined width (e.g., about 40-60 in (15.7-23.6 cm)). The woven fabric may then be extrusion coated with a thermoplastic elastomer (e.g., TPU) to produce a sheet of predetermined thickness and width (e.g., about 0.04 in (0.015 cm) thick by 40-60 in (102-152 cm), wide). Heated nip rollers, as are known in the art, may be used to provide adequate polymer flow and strike-through of the fiber structure. Depending on the level of strike-through, the fabric may be coated with polymer on either one or both sides.

A chemical cross-linking agent may be added to the thermoplastic elastomer during extrusion coating of the fiber reinforcement (e.g., dosed into the barrel of an extruder), When so employed, partial cross-linking between the reinforced layer materials occurs while the thermoplastic elastomer is at a relatively high temperature, promoting cross-linking of polymer chains between the fiber and the resin and within the body of the thermoplastic elastomer itself. The type and amount of chemical cross-linking agent may be selected to facilitate a relatively low level of cross-linking, sufficient to improve elevated temperature stability of the reinforced layer, but low enough so that additional flow and bonding may occur during subsequent high temperature processing operations.

In an exemplary implementation of the present invention, a medium durometer TPU made by BASF having material number 1185A10, was mixed with either of two experimental chemical cross linking agents (e.g., 7 w % Link 1.0 or 5 w % Link 2.0. A T-Peel test was then performed yielding a bond strength between the layers as high as 80% of the unmodified thermoplastic at bonding temperatures only slightly higher (e.g., 10-20° C.) than required for the unmodified, fully thermoplastic polymer. These results indicate that the polymer chains retain sufficient mobility for adequate thermal bonding and still allow thermal consolidation of the layers after wrapping.

Alternatively, the fiber or fabric may be coated with a chemical cross-linking agent prior to extrusion coating. During extrusion coating, the relatively hot thermoplastic elastomer contacts the coated fiber or fabric, activating the chemical cross-linking agent and causing localized cross-linking of the polymer chains between the fiber or fabric and the thermoplastic elastomer. This process improves fiber or fabric adhesion to the elastomer and long-term creep performance since the fiber is mechanically and chemically secured to the elastomer. A majority of the elastomer remains uncross-linked to preserve the thermoplastic behavior of the reinforced layer.

Similarly, each unreinforced elastomer layer 32 may be constructed by producing a semi-continuous sheet of unreinforced elastomer, such as by sheet or blown film extrusion. The reinforced and unreinforced sheets may then be slit or cut into individual strips of “tape,” each having a predetermined width.

In an embodiment, the tubular-shaped structure 24 is constructed by spiral wrapping individual strips of unreinforced elastomer “tape” onto a mandrel 38. The width of each tape strip may be selected to match the minor diameter, amount of overlap and fiber helix angle desired in a given wrap layer. To facilitate removal of the mandrel from the tubular-shaped structure, the mandrel may be coated with a release agent, such as zinc state or polyethylene film. While the mandrel shown in FIG. 3 is generally circular in cross-section, non-circular shaped mandrel may also be used, such as those having a generally oval shaped cross-section or a cross-section substantially similar to the tube cavity 30 shown in FIG. 1.

Referring to FIG. 3, two reinforced elastomer layers 32 are spiral-wrapped over the unreinforced elastomer layer 34; however, as noted above, the number of reinforced layers is not limited thereto. For the spiral-wrapped reinforced elastomer layers, the spiral angle is selected to provide an acceptable balance of strength and stiffness of the orthotopic fibers in the principal load direction of the tube. As shown in FIG. 5, the coordinates 1, 2, 3 of the reinforced elastomer layers are shown adjacent the coordinates X, Y, Z of the unreinforced elastomer layers 34, showing the relative angle θ therebetween representing the spiral angle, in FIG. 6, the spiral angles of two unreinforced layers 32 are shown relative to the radially extending axis R and axially extending axis φ of the tubular-shaped structure 24. For example, in clutch applications, the spiral angles +/−θ may be selected to be a minimum of about +/−45°. A second spiral-wrapped unreinforced elastomer layer 36 may then be placed over the reinforced elastomer layers 32 to produce a tube having a given length (e.g., about 100′ (30.5 m)). While the construction method described herein includes spiral wrapping each of the tube layers, it is not intended to be limited thereto. Alternatively, for example, the unreinforced layers 34, 36 may be extruded and the reinforced layers 32 may comprise a braided or spiral-applied fabric reinforcement. A chemical cross-linking agent may also be disposed between the unreinforced layers 34, 36 and reinforced layers 32. For example, when the unreinforced and reinforced layers are spiral wound, the chemical cross-linking agent may be applied as a coating over each wrapped layer excluding the outer layer. When a chemical cross-linking agent is employed between the unreinforced and reinforced layers, the thermal consolidation process activates, the cross-linking agent to bond the layers together, enhancing the overall structural integrity of the tubular-shaped structure and reducing the possibility for determination of the layers.

Prior to thermal consolidation of the layers, a nylon fabric tape or other suitable material (not shown in FIG.) may be spiral wrapped around the outer unreinforced elastomer 36 layer to apply a radially inwardly directed pressure onto the layers and to protect the tubular-shaped structure 24 during thermal consolidation. Thermal consolidation of the tubular-shaped structure 24 may be accomplished using a variety of methods, including, without limitation, heating the mandrel (electrical resistance, induction or heated fluid within the mandrel) or by inserting the entire tubular-shaped structure info a heated atmosphere, such as a steam autoclave or oven. In a steam autoclave, for example, temperature and pressure promote molecular mobility and bonding between the layers. It was determined that subjecting the tubular-shaped structure to saturated steam at approximately 293° F. for about 35 minutes was sufficient to bond and consolidate the tube structure described above using a relatively low hardness polyester thermoplastic urethane, such as Seaman 1940 PTFF

Following consolidation, the nylon tape is removed and the mandrel 38 may be extracted from the tubular-shaped structure 24, such as by using fluid pressure (e.g., high pressure wafer) to eject the mandrel. The continuous and still relatively straight tubular-shaped structure 24 may be permanently deformed using additional heat and pressure to obtain the generally fiat shape shown in FIG. 1. The flattened tubular-shaped structure 24 may then be cut info pieces having a predetermined length so that a closed toroidal-shaped tube may be formed when the ends of the cut length are joined to form the continuous cavity 30. Prior to joining, holes may be placed into a wall of the tube 12, such as by punching or cuffing, to accommodate air inlet and outlet valves 40 that connect the conduit 16 to the tube 12.

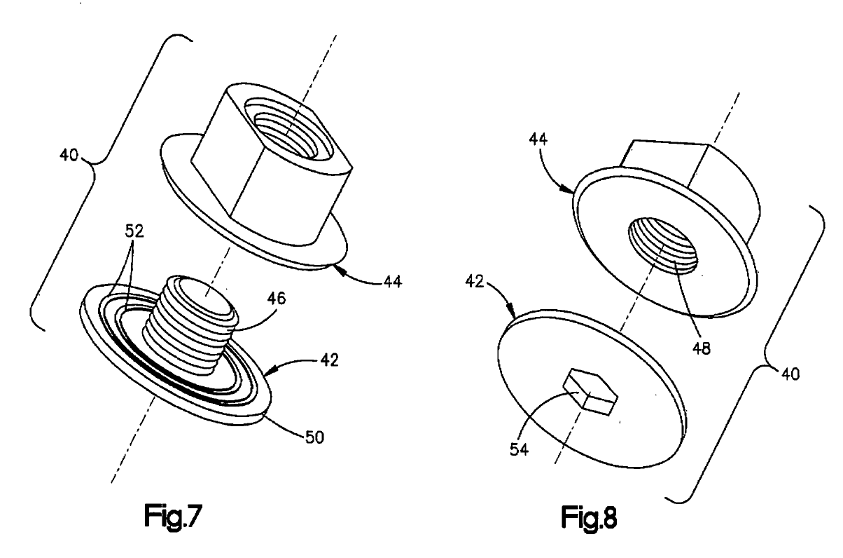

In the embodiment shown in FIGS. 7 and 8, the valve 40 includes an interior valve member 42 that is inserted into the interior of the tube 12 prior to joining and an exterior valve member 44 attached to the interior valve member prior to joining the ends of the tubular-shaped structure 24. The interior valve member includes a threaded male portion 46 that is adapted to thread into a corresponding threaded female portion 48 in exterior valve member 44. A generally fiat mating surface 50 in the interior valve member 42 includes at least one annular rib 52 that engages an interior surface of the cavity 40 to create an air-tight seal. A hexagonal hole 54 in the interior valve member 42 is adapted to interface with a correspondingly shaped hex-key tool (not shown), allowing the interior valve member 42 to be rotated relative to the exterior valve member 44 from outside of the tube 12 to assemble the valve 40.

The ends 26a, 26b of the straight tubular-shaped structure may be joined using a thermoset or thermoplastic adhesive. For thermoplastic tubes, a solvent bond or thermal weld may also be used to join the ends. Heat to effect a thermal weld may be generated using various sources, including, without limitation, a heated tool, hot gas, vibration, ultrasonic, induction, radio frequency, resistance, infrared and laser energy.

The invention has been described in great detail in the foregoing specification, and it is believed that various alterations and modifications of the invention will become apparent to those skilled in the art from a reading and understanding of the specification. If is intended that all such alterations and modifications are included in the invention, insofar as they come within the scope of the appended claims.

What is claimed is:

1. An inflatable coupling component tube for a fluid-operated brake or clutch, comprising:
an elongated, generally tubular-shaped structure of predetermined length having two ends and a joint between the two ends that closes the tube to form a generally toroidal-shaped cavity.

2. The tube of claim 1, wherein the generally tubular-shaped structure includes at least one reinforced layer and at least one unreinforced layer.

3. The tube of claim 2, wherein the generally tubular-shaped structure includes multiple reinforced layers.

4. The tube of claim 2, wherein the reinforced layer comprises a semi-continuous sheet of elastomer-coated, unidirectional fiber or fabric.

5. The tube of claim 4, wherein the fabric is coated with polymer on either one or both sides.

6. The tube of claim 2, wherein the unreinforced elastomer layer comprises a semi-continuous sheet of unreinforced elastomer.

7. The tube of claim 2, wherein the reinforced and unreinforced layers are spiral wrapped at a predetermined spiral angle.

8. The tube of claim 2, wherein the unreinforced layer is an extruded elastomer.

9. The tube of claim 2, wherein the reinforced layer comprises, a braided or spiral-applied fabric reinforcement.

10. The tube of claim 2, wherein at least one of the reinforced layer and the unreinforced layer includes a thermoplastic elastomer.

11. The tube of claim 2, wherein the thermoplastic elastomer is at least partially chemically cross-linked.

12. The tube of claim 2, further including an interior valve member and an exterior valve member attached to the interior valve member, the interior valve member including a threaded male portion adapted to thread into a corresponding threaded female portion in exterior valve member and a generally fiat mating surface in the interior valve member having at least one annular rib that engages an interior surface of the cavity to create an air-tight seal.

13. The tube of claim 1, wherein the generally tubular-shaped structure includes at least one reinforced layer sandwiched between an inner, unreinforced layer and an outer, unreinforced layer.

14. The tube of claim 1, wherein the joint includes one of a thermoset or thermoplastic adhesive, a solvent bond, and a thermal weld.

15. A coupling component for a fluid-operated brake or clutch, comprising:
an inflatable toroidal-shaped tube having an annular array of friction shoe assemblies engageable with a second coupling component to interconnect the two coupling components, the tube comprising an elongated, generally tubular-shaped structure of predetermined length having two ends and a joint between the two ends that closes the toroidal-shaped tube to form a generally toroidal-shaped cavity.

16. The coupling component of claim 15, wherein the generally tubular-shaped structure includes at least one reinforced layer and at least one unreinforced layer.

17. The coupling component of claim 16, wherein the generally tubular-shaped structure includes multiple reinforced layers.

18. The coupling component of claim 16, wherein the reinforced layer comprises a semi-continuous sheet of elastomer-coated, unidirectional fiber or fabric.

19. The coupling component of claim 18, wherein the fabric is coated with polymer on either one or both sides.

20. The coupling component of claim 16, wherein the unreinforced elastomer layer comprises a semi-continuous sheet of unreinforced elastomer.

21. The coupling component of claim 16, wherein the reinforced and unreinforced layers are spiral wrapped at a predetermined spiral angle.

22. The coupling component of claim 16, wherein the unreinforced layer is an extruded elastomer.

23. The coupling component of claim 16, wherein the reinforced layer comprises a braided or spiral-applied fabric reinforcement.

24. The coupling component of claim 16, wherein at least one of the reinforced layer and the unreinforced layer includes a thermoplastic elastomer.

25. The coupling component of claim 16, wherein the thermoplastic elastomer is at least partially chemically cross-linked.

26. The coupling component of claim 16, further including an interior valve member and an exterior valve member attached to the interior valve member, the inferior valve member including a threaded male portion adapted to thread into a corresponding threaded female portion in exterior valve member and a generally flat mating surface in the interior valve member having at least one annular rib that engages an interior surface of the cavity to create an air-tight seal.

27. The coupling component of claim 15, wherein the generally tubular-shaped structure includes at least one reinforced layer sandwiched between an inner, unreinforced layer and an outer, unreinforced layer.

28. The tube of claim 1, wherein the joint: includes one of a thermoset or thermoplastic adhesive, a solvent bond, and a thermal weld.

29. A method for making a coupling component tube for a fluid-operated clutch or brake, comprising the steps of:
constructing an elongated generally tubular-shaped structure;
cutting the elongated tubular-shaped structure into a separate piece having a predetermined length;
manipulating the separate piece to form a closed generally toroidal-shaped tube having first and second ends; and
joining the first and second ends.

30. The method of claim, wherein the constructing step includes spiral wrapping at least one reinforced layer and spiral wrapping or extruding at least one unreinforced layer over a mandrel.

31. The method of claim 29, wherein the constructing step includes thermally consolidating the reinforced and unreinforced layers.
